(19) United States
(12) Patent Application Publication
(10) Pub. No.: US 2006/0206888 A1
(43) Pub. Date: Sep. 14, 2006

(54) Checking for and accessing software component updates through a common content manager

(75) Inventors: Erik C. Mavrinac, Bothell, WA (US); Mark D. Zuber, Duvall, WA (US)

Correspondence Address: WORKMAN NYDEGGER/MICROSOFT, 1000 EAGLE GATE TOWER, 60 EAST SOUTH TEMPLE, SALT LAKE CITY, UT, 84111, US

(73) Assignee: Microsoft Corporation, Redmond, WA (US)

(21) Appl. No.: 11/078,877

(22) Filed: Mar. 11, 2005

(51) Int. Cl. G06F 9/44

(52) U.S. Cl. 717/168

(57) ABSTRACT

The present invention extends to checking for and accessing software component updates through a common content manager. A content communication aggregates the received message states of software components into a aggregated update request representing the message state of the software components. The content communication manager sends and a content manger receives the aggregated update request. The content manager determines if updated content for any software components is available. The content manager generates a message list including any messages that are to be sent to the one or more software components. Each message in the message list corresponds to a software component and indicating if any content is available for the software component. The content manager sends and the content communication manager receives the message list. The content communication manager distributes messages to corresponding software components such that the software components can subsequently access any available content.

### CROSS-REFERENCE TO RELATED APPLICATIONS

Not applicable.

### BACKGROUND OF THE INVENTION

1. The Field of the Invention

The present invention relates to updating content and, more particularly, to checking for and accessing software component updates through a common content manager.

2. Background and Relevant Art

Computer systems and related technology affect many aspects of society. Indeed, the computer system's ability to process information has transformed the way we live and work. For example, computer systems typically include software applications for performing a host of tasks (e.g., word processing, scheduling, and database management) that prior to the advent of the computer system were performed manually. A computer system can also include maintenance, diagnostic, and security applications (e.g., backup applications, health checkers, anti-virus applications, firewalls, etc.) that help to insure that the computer system remains, or can be returned to, an appropriate operating state. For example, an anti-virus application can detect and eliminate computer viruses before any harm is done to the computer system.

Many computer systems are also typically coupled to one another and to other electronic devices to form both wired and wireless computer networks over which the computer systems and other electronic devices can transfer electronic data. As a result, many tasks performed at a computer system (e.g., voice communication, accessing electronic mail, controlling home electronics, Web browsing, and printing documents) include the exchange of electronic messages between a number of computer systems and/or other electronic devices via wired and/or wireless computer networks.

Networks have in fact become so prolific that a simple network-enabled computing system may communicate with any one of millions of other computing systems spread throughout the globe over a conglomeration of networks often referred to as the “Internet”. Such computing systems may include desktop, laptop, or tablet personal computers; Personal Digital Assistants (PDAs); telephones; or any other computer or device capable of communicating over a digital network.

Due at least in part to the proliferation network computing, many software vendors provide network based updates for their applications. This makes updates available to large numbers of users in a cost efficient manner (e.g., as opposed to burning and shipping up CDs). For example, a vendor can include the latest versions and/or upgrades for their applications at a company Web site on the Internet. Thus, any user (with Internet access) can access the Web site and download updates to their computer system. Downloaded updates can then be installed at the computer system.

Some vendors integrate network-based update capability into their applications. For example, applications can include an “update” control that, when selected, connects to a known network location and checks for updates. Still other applications automatically check for updates without requiring the selection of an “update” control. In any event, these applications can then present a list of available updates (either before or after the updates are downloaded) to a user for selection. Any selected updates can then be (if appropriate, downloaded and) installed on the computer system.

However, each application typically includes a proprietary mechanism (e.g., proprietary interface, proprietary protocol, etc.) to check for available updates and then, if appropriate, downloading updates to a computer system. Further, update protocols for different applications are often incompatible with one another. For example, an anti-virus application typically can not use the update mechanism of a word processing application to check for and download updates. Thus, there is typically no way for a computer system to check for updates (for a number of different applications) at a single location and/or to receive an indication of all available updates (for a number of different applications) from a single location. As a result, a computer system is often required to separately contact a variety of different update locations (potentially one for each application) to keep its software updated. This multiplicity in checking for updates consumes network bandwidth, and when there are no updates, may be unnecessary.

Therefore systems, methods, and computer program products that check for and access software component updates through a common content manager would be advantageous.

### BRIEF SUMMARY OF THE INVENTION

The foregoing problems with the prior state of the art are overcome by the principles of the present invention, which are directed towards methods, systems, and computer program products for checking for and accessing software component updates through a common content manager. A content communication manager receives message states from one or more software components. The content communication manager aggregates the received message states into an aggregated update request that includes name/value pairs representing the message state of each of the one or more software components.

The content communication manager sends the aggregated update request to a content manager. The content manager receives the aggregated update request from the content communication manager. The content manager compares the message state for at the least one software component to a corresponding updated message state for the at least one software component. The content manager generates a message list configured to include any messages that are to be sent to the one or more software components. Each message in the message list corresponding to a software component and indicating if any content is available for the software component.

The content manager generates a message that indicates any updated content available to the at least one software component. The content manager includes the generated message in the message list. The content manager sends the message list to the content communication manager in response to the aggregated update request such the relevant messages can be distributed to the one or more software components. The content communication manager receives the message list. The content communication manager distributes the one or more messages to corresponding software components such that the software components can subsequently access any available content.

These and other objects and features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 illustrates an example of a computer architecture that facilitates checking for and accessing software component updates through a common content manager.

FIG. 2 illustrates an example flow chart of a method for checking for and accessing software component updates through a common content manager.

FIG. 3 illustrates a suitable operating environment for the principles of the present invention.

### DETAILED DESCRIPTION OF THE PREFERRED EMBODIMENTS

The foregoing problems with the prior state of the art are overcome by the principles of the present invention, which are directed towards methods, systems, and computer program products for checking for and accessing software component updates through a common content manager. A content communication manager receives message states from one or more software components. The content communication manager aggregates the received message states into an aggregated update request that includes name/value pairs representing the message state of each of the one or more software components.

The content communication manager sends the aggregated update request to a content manager. The content manager receives the aggregated update request from the content communication manager. The content manager compares the message state for the at least one software component to a corresponding updated message state for the at least one software component. The content manager generates a message list configured to include any messages that are to be sent to the one or more software components. Each message in the message list corresponding to a software component and indicating if any content is available for the software component.

The content manager generates a message that indicates any updated content available to the at least one software component. The content manager includes the generated message in the message list. The content manager sends the message list to the content communication manager in response to the aggregated update request such the relevant messages can be distributed to the one or more software components. The content communication manager receives the message list. The content communication manager distributes the one or more messages to corresponding software components such that the software components can subsequently access any available content.

Embodiments within the scope of the present invention include computer-readable media for carrying or having computer-executable instructions or data structures stored thereon. Such computer-readable media may be any available media, which is accessible by a general-purpose or special-purpose computer system. By way of example, and not limitation, such computer-readable media can comprise physical storage media such as RAM, ROM, EPROM, CD-ROM or other optical disk storage, magnetic disk storage or other magnetic storage devices, or any other media which can be used to carry or store desired program code means in the form of computer-executable instructions, computer-readable instructions, or data structures and which may be accessed by a general-purpose or special-purpose computer system.

In this description and in the following claims, a “network” is defined as one or more data links that enable the transport of electronic data between computer systems and/or modules. When information is transferred or provided over a network or another communications connection (either hardwired, wireless, or a combination of hardwired or wireless) to a computer system, the connection is properly viewed as a computer-readable medium. Thus, any such connection is properly termed a computer-readable medium. Combinations of the above should also be included within the scope of computer-readable media. Computer-executable instructions comprise, for example, instructions and data which cause a general-purpose computer system or special-purpose computer system to perform a certain function or group of functions. The computer executable instructions may be, for example, binaries, intermediate format instructions such as assembly language, or even source code.

In this description and in the following claims, a “computer system” is defined as one or more software modules, one or more hardware modules, or combinations thereof, that work together to perform operations on electronic data. For example, the definition of computer system includes the hardware components of a personal computer, as well as software modules, such as the operating system of the personal computer. The physical layout of the modules is not important. A computer system may include one or more computers coupled via a network. Likewise, a computer system may include a single physical device (such as a mobile phone or Personal Digital Assistant “PDA”) where internal modules (such as a memory and processor) work together to perform operations on electronic data.

Those skilled in the art will appreciate that the invention may be practiced in network computing environments with many types of computer system configurations, including, personal computers, laptop computers, hand-held devices, multi-processor systems, microprocessor-based or programmable consumer electronics, network PCs, minicomputers, mainframe computers, mobile telephones, PDAs, pagers, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

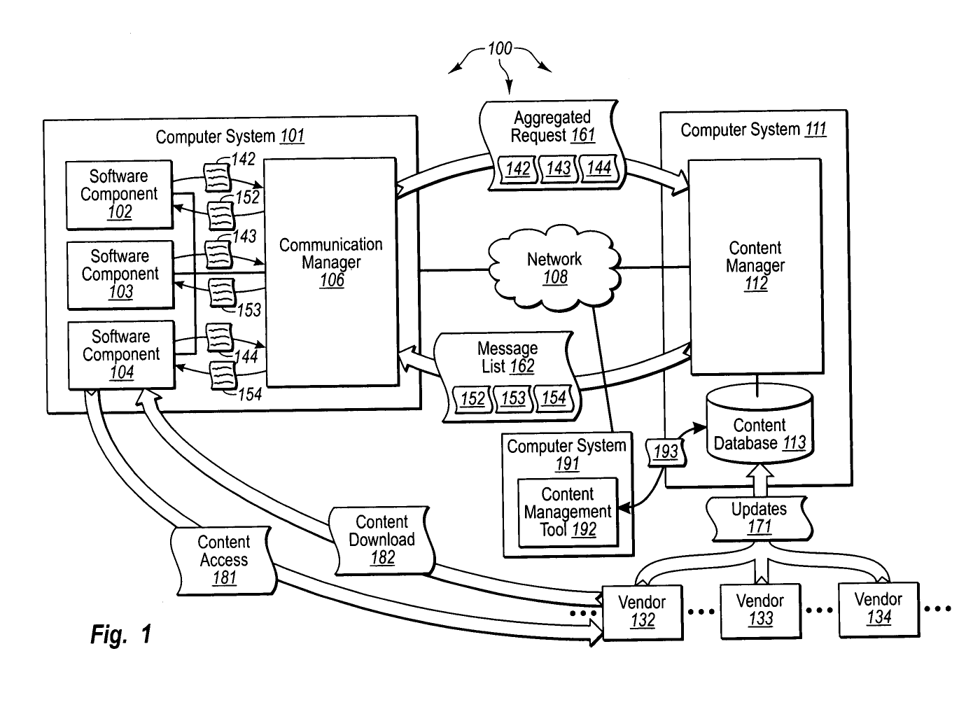

FIG. 1 illustrates an example of a computer architecture 100 that facilitates checking for and accessing software component updates through a common content manager. As depicted in computer architecture 100 computer systems 101, 111, and 191 are connected to network 108. Network 108 can be a Local Area Network (“LAN”), Wide Area Network (“WAN”), or even the Internet. Computer systems connected to network 108 can receive data from and send data to other computer systems connected to network 108. Accordingly, computer systems 101, 111, 191, as well as other connected computer systems (not shown), can create message related data and exchange message related data (e.g., Internet Protocol (“IP”) datagrams and other higher layer protocols that utilize IP datagrams, such as, Transmission Control Protocol (“TCP”), Hypertext Transfer Protocol (“HTTP”), Simple Mail Transfer Protocol (“SMTP”), etc.) over network 108. For example, computer systems 101, 111, and 191 can create SOAP envelopes and exchange SOAP envelopes (including XML data) over network 108.

Computer system 101 includes communication manager 106 and software components 102, 103, and 104. Software components 102, 103, and 104 can be virtually any type of software module, such as, for example, an application program (e.g., electronic mail application, Web browser, database access module, word processor, etc) or portion thereof, an operating system component (e.g., file system, user-interface, hardware driver) or a portion thereof, a communication component (e.g., a network stack) or portion thereof, etc. From time to time, or in response to some event, software components 102, 103 and 104 can indicate a current message state to content communication manager 106.

A message state can include the version of a corresponding software component, the last time a corresponding software component was updated, the last time a corresponding software component queried for updated content, etc. A message state for a software component can be represented in one or more name/value pairs. Each name/value pair can represent the state of a particular characteristic of the software component.

Content communication manger 106 is configured to receive message states from one or more software components, aggregate the message states into an aggregated request for updated content, and send aggregated requests to a content manager to request content updates. Content communication manager 106 is also configured to receive a message list and distribute messages included in the message list to the corresponding software components.

When a message includes updated content, the updated content can be used to update the corresponding software component, such as, for example, to update an executable to a more recent version or to present a notification. When a message includes a reference to updated content, such as, for example, a Uniform Resource Location (“URL”), a corresponding software component can use the reference to access the updated content.

Computer system 111 includes content manager 112 and content database 113. Content manager 112 is configured to receive aggregated requests and, from the aggregated request, identify content that is to be used to update software components of a computer system. Content database 113 can include content that is to be used to update a software component. For example, content database 113 can include a software patch that is to be applied to a software component or a notification message that is to be presented at a software component. Content database 113 can also include references to content that is to be used to update a software component. For example, content database 113 can include a URL referencing a location of a software patch.

Content manager 112 is configured to compare message states (e.g., name/value pairs) in an aggregated request to update message states (e.g., other corresponding name/value pair) to determine if any updates are available for a software component. For example, content manager 112 can query content database 113 for the name portion of a received name/vale pair. If the name portion is included in content database 113, content manager 112 can then compare the received value portion of the name value pair to the corresponding value in content database 113. When the comparison indicates that an update is available (e.g., when the received version number is lower than the latest released version number), updated content or a reference to updated content can be returned to the appropriate content communication manager.

Content updates can be transferred to content database 113 using a variety of different mechanisms. For example, updates can be transferred using electronic messages, computer-readable (e.g., floppy disks, flash drives), etc. In some embodiments, vendors directly update their content in content database 113. Depicted in architecture 100 are vendors 132, 133, and 134. Each of the vendors 132, 133, and 134 can submit appropriate content updates, collectively represented as updates 171, to content database 113. For example, if vendor 132 was the developer of a word processing application, vendor 132 can send updated content or references to updated content for the word processing application to content database 113.

After identifying available content updates, content manager 112 can include the updates into messages for corresponding software components. Content manager 112 can then aggregate the messages into a message list. Content manager 112 can send the message list back to a content communication manager in response to receiving an aggregated request from the content communication manager.

Computer system 191 includes content management tool 192. Content management tool 192 is configured to update content database 113. For example, update 193 represents content management tool 192 adding messages (or other content) to and/or deleting messages (or other content) from content database 113. Although depicted as separate computer systems, computer systems 111 and 191 can be under the control of the same administrative entity. Thus, as an alternative to direct vendor updates, vendors can supply or at least indicate updates to the administrative entity. The administrative entity can then configure content management tool 192 to implement the updates in content database 113. Optionally, an administrator can access content database 113 through an appropriate interface and manually update content database 113.

It should be understood that although FIG. 1 depicts various components as being included in the same computer system (e.g., software components 102, 103 and 104 and communication manager 106 included in computer system 101 and content manager 112 and content database 113 included in computer system 111), it should be understand that the various components can be distributed across different computer systems. For example, content manager 112 and content database 113 can reside at different computer systems. Thus, content management tool 192 and vendors 132, 133, and 134 can provide content updates at one computer system and indications of available updates as well as content can be provided at another different computer system.

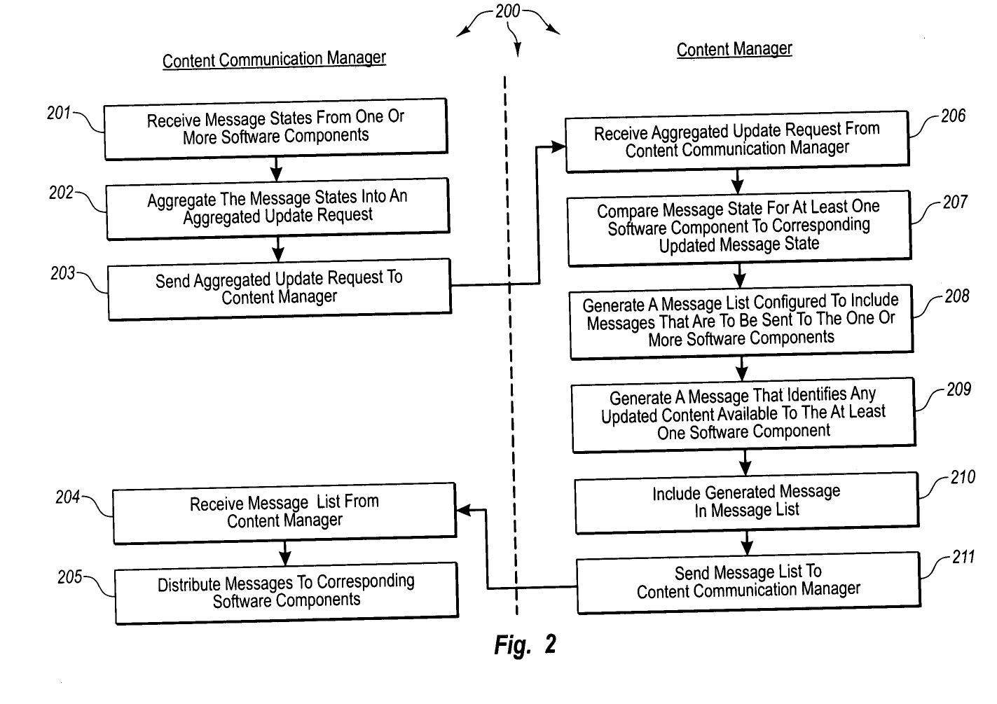

FIG. 2 illustrates an example flow chart of a method 200 for checking for and accessing software component updates through a common content manager. The method 200 will be described with respect to the components, managers, and data in computer architecture 100.

Method 200 includes an act of receiving message states from one or more software components (act 201). For example, content communication manager 106 can receive message states 142, 143, and 144 from software components 102, 103, and 104 respectively. Each received message state can include one or more name/value pairs that represent a sub-part of the corresponding software component's state. For example, message state 142 can include one or more name/value pairs that represent a sub-part of software component 102's state.

Method 200 includes an act of aggregating the messages states into an aggregated update request (act 202). For example, content communication manager 106 can aggregate message states 142, 143, and 144 into aggregated request 161. Aggregated request 161 can be formatted in a variety of different ways. In some embodiments, an aggregated request includes a protocol revision number and a series of name/value pairs, each name/value pair providing a particular sub-part of the computer system's state. For example, aggregated request 161 can include a protocol revision number and series of name/value pairs (e.g., from message states 142, 143, and 144), each name value pair providing a particular sub-part of computer system 101's state. Each name/value pair and the revision number can be separated by a separator specific to the underlying transport protocol used.

A revision number indicates the revision of the protocol in use by a computer system. A particular revision of the protocol matches an expected and required set of name/value pairs to provide state. A revision number can be a positive integer and can start at the value 1 for the first revision of the protocol. Absence of the revision number, an unsupported revision number, or deviation from the exact set of name/value pairs correspond to a revision, can result in rejection of a computer system's request by a content manager.

As previously described, a (single) name/value pair can provide a corresponding sub-part of computer system state for consideration by a content manager in determining what messages to return to the computer system. The number of name/value pairs that can be included in an aggregated request is unbounded. In some embodiments, a particular protocol revision can set an exact, finite number and format of name/value pairs. The name portion of name/value pairs can be unique names determined by a particular revision of the protocol, matching independent parts of computer system message state. The format of the value portion of a name/value pairs can be determined by the protocol.

A wide variety of different value formats can be used. For example, a value can be formatted as a globally unique identifier (“GUID”) data type. In some embodiments, a GUID specifies a 128-bit value with the form “{xxxxxxxx-xxxx-xxxx-xxxx-xxxxxxxxxxxx}” where each ‘x’ is a hexadecimal digit. A value can also be formatted as a string choice. In some embodiments, a string choice specifies one of a set of predefined string values for a particular name/value pair. For example, a name/value pair can specify a two-character language code (e.g., “EN” for U.S. English) or any of several other languages. Another example is a one-character operating system code (e.g. “x” for Windows XP Home or Professional Editions).

A value can also be formatted as a variable-length hexadecimal encoding of a four-part, 64-bit decimal integer version number. In some embodiments, a variable-length hexadecimal encoding of a four-part, 64-bit decimal integer version number an encoding for version numbers used by the computer system and provided to a content manager. A four-part version number can include four non-negative integer values separated by three dots (‘.’), such as, for example, “0.6.400.0”. A variable-length hexadecimal encoding for such a version string translates each part of the version into a four-character hexadecimal value, with no separators. Trailing zeroes can be truncated in groups of four, and up to three leading zeroes may be truncated, to conserve network bandwidth. For example, the example version number above (“0.6.400.0”) would translate into “0000000601900000” but may be truncated to “000060190” to save space.

Name/value pair separators can be selected based on an underlying protocol and, in some embodiments, are implementation-dependent. For example, for an HTTP GET transport protocol, an ampersand character ‘&’ can be used for a separator. However, a wide variety of different transport protocols can be used to send an aggregated request.

Depicted below is an example string representing a request format:
“r=1&avb=0&avbs=0&ave=0&avss=0&fws=0&g1=01&g2=GN&1=EN&o=x&p=8&s={3b30b914-c8f6-4969-b2d6-cd2a7830bd93}&v=0000000601D30000”

The preceding string represents a request using protocol revision 1 (“r=1”), along with several name-value pairs (avb, avbs, ave, avss, fws, and v using the variable-length hexadecimal version encoding; g1, g2, 1, o, and p using string choices of varying lengths, and s as a GUID value). It may be that the name portion of name/value pairs that begin with “av” correspond to an anti-virus software component. Similarly, it may be that the name portion of name/value pairs that begin with “fw” correspond to a firewall software component. The name portion of name/value pairs that begin with “g” can correspond to some other software component. The name portion of the name/value pair that begins with “1” can correspond to the language. The name portion of name/value pair that begins with “o” can correspond to an operating system. The name portion of name/value pairs that begin with “p” can correspond to an operating system variable. Value portions of any name/value pair represent current values at the computer system that generated the aggregated request.

Method 200 includes an act of sending the aggregated update request to a content manager (act 203). For example, content communication manger 106 can send aggregated request 161, including message states 142, 143, and 144, to content manager 112. In some embodiments, a request string is included in a Uniform Resource Locator (“URL”) that also includes a path to a content manager. For example, the previously described example string can be included in the URL:
“http://<machine name>/<path to content manager>/r=1&avb=0&avbs=0&ave=0&avss=0&fws=0&gl=01&g2=GN&1=EN&o=x&p=8&s={3b30b914-c8f6-4969-b2d6-cd2a7830bd93}&v=0000000601D30000”

Where <machine name> is an Internet Protocol (“IP”) address or domain name of a computer system that includes a content manager. Thus, the previously described example string can be provided as input (indicating the message state of a corresponding software component) to the content manager.

Method 300 includes an act of receiving the aggregated update request form the content communication manager (act 206). For example, content manager 112 can receive aggregated request 161 from content communication manager 106. In some embodiments, computer system 111 receives a URL containing a path to content manager 112 and a string representing an aggregated request. In response, computer system 111 transfers the string representing the aggregated request to content manager 112.

Method 300 includes an act of comparing message state for at least one software component to corresponding updated message state (act 207). For example, content manager 112 can compare message state for at least one of software components 102, 103, and 104 to updated message state in content database 113. Comparing message state can include comparing value portions of name/value pairs included in aggregated request 161 to value portions of name/value pairs included in content database 113.

Method 200 includes an act of generating a message list configured to include messages that are to be sent to the one or more software components (act 208). For example, content manager 112 can configure message list 112 to include messages that are to be sent to at least one of software components 102, 103, and 104. A message list can be formatted in accordance with a response format. The following is an example message list XML Schema Definition (“XSD”) document describing the format of a message list:

| | |
|---|---|
| 1. | <?xml version=“1.0” encoding=“utf-8” ?> |
| 2. | <xs:schema id=“ProvisionInfo” |
| | targetNamespace=“http://<machine name>/<path>/UpdateMessages.xsd” |
| | lementFormDefault=“qualified” xmlns=“http://<machine name> /<path>/UpdateMessages.xsd” |
| | xmlns:mstns=“http://<machine name> /<path>/UpdateMessages.xsd” |
| | xmlns:xs=“http://www.w3.org/2001/XMLSchema”> |
| 3. | <xs:simpleType name=“shortString5”> |
| 4. | <xs:restriction base=“xs:string”> |
| 5. | <xs:minLength value=“1” /> |
| 6. | <xs:maxLength value=“5” /> |
| 7. | </xs:restriction> |
| 8. | </xs:simpleType> |
| 9. | <xs:simpleType name=“guid”> |
| 10. | <xs:restriction base=“xs:string”> |
| 11. | <xs:pattern value=“♯{[0-9a-fA-F]{8}-[0-9a-fA-F]{4}-[0-9a-fA-F]{4}-[0-9a-fA-F]{4}-[0-9a-fA- |
| | F]{12}♯}” /> |
| 12. | </xs:restriction> |
| 13. | </xs:simpleType> |
| 14. | <xs:element name=“Msgs”> |
| 15. | <xs:complexType> |
| 16. | <xs:sequence> |
| 17. | <xs:element name=“Msg” type=“Msg” minOccurs=“0” maxOccurs=“unbounded” /> |
| 18. | </xs:sequence> |
| 19. | <xs:attribute name=“Ver” type=“xs:integer” use=“required” /> |
| 20. | <xs:attribute name=“Retry” type=“xs:integer” use=“optional” /> |
| 21. | <xs:attribute name=“TS” type=“xs:string” use=“optional” /> |
| 22. | </xs:complexType> |
| 23. | </xs:element> |
| 24. | <xs:complexType name=“Msg”> |
| 25. | <xs:attribute name=“ID” type=“guid” use=“required” /> |
| 26. | <xs:attribute name=“TS” type=“xs:string” use=“required” /> |
| 27. | <xs:attribute name=“SS” type=“shortString5” use=“required” /> |
| 28. | <xs:attribute name=“URL” type=“xs:string” use=“optional” /> |
| 29. | </xs:complexType> |
| 30. | </xs:schema> |

Lines 3-8 define a shortString5 as a string that can have a length between one and five characters. Lines 9-13 define a guid as a string that can include various hexadecimal values in the form of <eight digit hexadecimal value>-<four digit hexadecimal value>-<four digit hexadecimal value>-<four digit hexadecimal value>-<four digit hexadecimal value>-<twelve digit hexadecimal value>.

Lines 14-23 define a message list (“Msgs”) of zero or more individual messages being returned by a content manager. The “Ver” attribute is used to represent the version of the protocol. The value of the “Ver” attribute can be set to “1” to indicate that version 1 of this XML format is being supplied to requesting computer systems. The “Retry” attribute is used to indicate to a requesting computer system that a content manager is busy and the computer system is to send another request at a later time. The value of the “Retry” attribute can be set to “1” to indicate to a requesting computer system that the message list will be zero length and that the requesting computer system is to retry the request later (reasons for the server to return this retry indication are server implementation dependent). The “TS” attribute is used to timestamp any returned messages. The value of the “TS” attribute can be set to the date/time in Universal Time when a message list was generated.

Lines 24-29 define a message (“Msg”), which can be a message included in a message list (as indicated at line 17). The “ID” attribute provides an identifier, such as, for example, a GUID for this unique message. The “TS” attribute specifies a timestamp, such as, for example, the date/time in Universal Time when this message was created. The “SS” attribute is a 1-5 character string value (shortString5) that identifies the intended message recipient (subsystem, software component, etc.) at a requesting computer system.

A set of valid values for the SS attribute can implementation-dependent. The “URL” attribute specifies an optional URL reference to information for use by the particular subsystem (software component) at the client in retrieving further information (e.g., a software patch) related to the message. A message can also potentially include a data block, such as, for example, a XML-standard CDATA block, containing content. Formats for this message text can be implementation-dependent.

Method 200 includes an act of generating a message that identifies any updated content available to the at least one software component (act 209). For example, in response to detecting available updated content for at least one of software components 102, 103, and 104, content manager 112 can generate at least one corresponding message (e.g., message 152, 153, or 154) that identifies the available updated content. For example, if it is detected that updated content is available for software component 102, content manager 112 can generate message 152 that identifies software component 102's available updated content.

Similarly, if it is detected that updated content is available for software component 103, content manager 112 can generate message 153 that identifies software component 103's updated content. Likewise, if it is detected that updated content is available for software component 104, content manager 112 can generate message 154 that identifies software component 104's updated content. Content manager 112 can also generate other corresponding messages for other software components (at computer system 101 or at other computer systems).

Updated content can be content that was provided by an administrator of computer system 191, by content management tool 192, and/or by any of vendors 132, 133, and 143.

Thus, various different types of messages, formatted in accordance with the example message list XSD document, can be included in a message list. A message list can include a message that contains updated content, such as, for example:

| | |
|---|---|
| 41. | <Msg ID=“{8c8b81e7-d659-4d9a-a4f9-b0754ae64940}” |
| | SS=“CompA” TS=“2004-11-06 02:57:42”> |
| 42. | <![CDATA[Updated Content]}> |
| 43. | </Msg> |

Line 41 represents a message that is designated for sub-system “CompA” (e.g., Component A or one of software components 102, 103 or 104). Line 41 also includes a message ID identifying the message and a Timestamp indicating when the message was generated (e.g., by content manager 112). Line 42 represents a CDATA block containing updated content (e.g., a notification or software patch) that is to be delivered to “CompA”.

A message list can also include a message that contains a reference to updated content, such as, for example:

| | |
|---|---|
| 44. | <Msg ID=“{6636A8CD-3B5D-4B61-950C-28C049516E76}” |
| | TS=“2004-11-06 02:57:44” SS=“CompB” |
| | URL=“http://<machine name>/<path>” /> |

Line 44 represents a message that is designated for “CompB” (e.g., component B or another of software components 102, 103 or 104) and indicates that update content for “CompA” is located at the URL “http://<machine name>/ <path>”. Line 44 also includes a message ID identifying the message and a Timestamp indicated when the message was generated (e.g., by content manager 112).

The method 200 includes an act of including the generated message in the message list (act 210). For example, content manager can include messages 152, 153 and 154, designated for software components 102, 103, and 104 respectively, in message list 162. Thus, it may be that a various different messages are included in the same message list. For example, the message of lines 41-43 and the message of line 44 can be included in a message list as follows:

| | |
|---|---|
| 40. | <Msgs Ver=“1” TS=“2004-11-06 02:57:45”> |
| 41. | <Msg ID=“{8c8b81e7-d659-4d9a-a4f9-b0754ae64940}” |
| | SS=“CompA” TS=“2004-11-06 02:57:42”> |
| 42. | <![CDATA[Updated Content]}> |
| 43. | </Msg> |
| 44. | <Msg ID=“{6636A8CD-3B5D-4B61-950C-28C049516E76}” |
| | TS=“2004-11-06 02:57:44” SS=“CompB” |
| | URL=“http://<machine name>/<path>” /> |
| 45. | </Msgs> |

Line 40 includes a version number indicating a version of the update protocol and a Timestamp indicating when the message list (e.g., message list 162) was generated.

The method 200 includes an act of sending the message list to the content communication manger (act 211). For example, content manager 112 can send message list 162, including messages 152, 153, and 154, to content communication manager 106.

If a content manager (e.g., content manger 112) can not respond to a request, the content manager can return a retry later message list, such as, for example:
50.<Msgs Ver=“1” Retry=“1”/>

Line 50 includes a version number indicating a version of the update protocol and a Retry value set equal to “1”. A Retry value equal to “1” indicates to a content communication manager (e.g., content communication manger 106) that it is to resubmit the request (e.g., aggregated request 161) at a later time (e.g., a specified interval).

If a content manager (e.g., content manager 112) does not identify any updated content in response to a request (e.g., aggregated request 161), the content manager can return an empty message list, such as, for example:
60.<Msgs Ver=“1”TS=“2004-11-06 02:57:44”/>

Line 60 includes a version number indicating a version of the update protocol and a Timestamp indicating when the message list (e.g., message list 162) was generated. The “/” indicates the end of the message list.

When there is an error (e.g., a catastrophic error or reception of an improperly formatted message) in receiving a request, a content manager (e.g., content manager 112) can respond with an error condition using a lower layer protocol (e.g., TCP or HTTP). For example, a content manager can respond with a “404 Not Found” error response code (via HTTP).

Method 200 includes an act of receiving the message list from the content manager (act 204). For example, content communication manager 204 can receive message list 162, including messages 152, 153, and 154, from content manager 112. Method 200 includes an act of distributing messages to corresponding software components (act 205). For example, content communication manager 106 can distribute message 152 to software component 102, can distribute message 153 to software component 103, and can distribute message 154 to software component 104. Content communication manager 106 can refer to the value portion of name/value pairs having a name portion of “SS” to determine how to distribute messages in message list 162. For example, a message including the name/value pair: SS=“SC102”, can be delivered to software component 102.

Updated content included in messages can be processed at a receiving software component. For example, software components 102 and 103 can process content included in messages 152 and 153 respectively. When a message includes a reference to updated content, a software component can use the reference to access the update content. For example, software component 104 can use a URL for vendor 132 to access updated content from vendor 132. For example, software component 104 can send content access 181 to vendor 132 to initiate content download 182.

Thus, embodiments of the present invention facilitate notifying a plurality of software components (potentially developed by different vendors) of the availability of content updates through a common content manager. Thus, content updates for the plurality of software components can be managed through a single location thereby simplifying the update process. Further, content update requests from a plurality of different software components can be aggregated into a single request message. Likewise, any updated content and/or references to updated content for the plurality of different software components can be aggregated in a single message list. Accordingly, network bandwidth is potentially conserved.

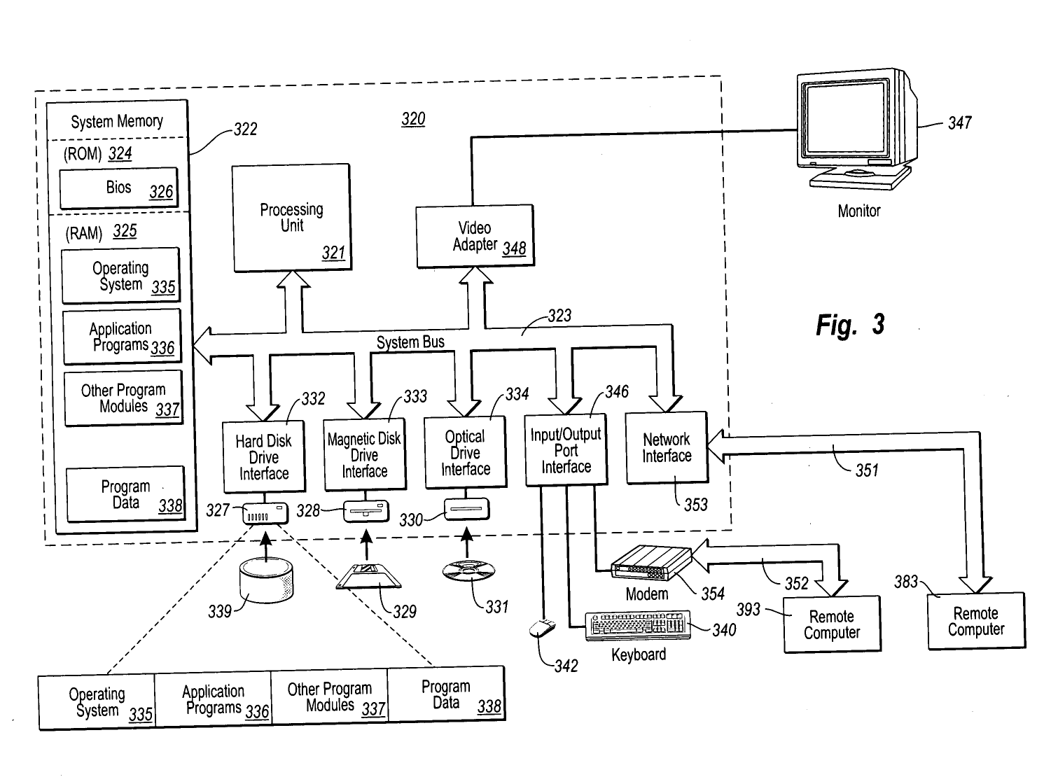

FIG. 3 illustrates a suitable operating environment for the principles of the present invention. FIG. 3 and the following discussion are intended to provide a brief, general description of a suitable computing environment in which the invention may be implemented. Although not required, the invention will be described in the general context of computer-executable instructions, such as program modules, being executed by computer systems. Generally, program modules include routines, programs, objects, components, data structures, and the like, which perform particular tasks or implement particular abstract data types. Computer-executable instructions, associated data structures, and program modules represent examples of the program code means for executing acts of the methods disclosed herein.

With reference to FIG. 3, an example system for implementing the invention includes a general-purpose computing device in the form of computer system 320, including a processing unit 321, a system memory 322, and a system bus 323 that couples various system components including the system memory 322 to the processing unit 321. Processing unit 321 can execute computer-executable instructions designed to implement features of computer system 320, including features of the present invention. The system bus 323 may be any of several types of bus structures including a memory bus or memory controller, a peripheral bus, and a local bus using any of a variety of bus architectures. The system memory includes read only memory (“ROM”) 324 and random access memory (“RAM”) 325. A basic input/output system (“BIOS”) 326, containing the basic routines that help transfer information between elements within computer system 320, such as during start-up, may be stored in ROM 324.

The computer system 320 may also include magnetic hard disk drive 327 for reading from and writing to magnetic hard disk 339, magnetic disk drive 328 for reading from or writing to removable magnetic disk 329, and optical disk drive 330 for reading from or writing to removable optical disk 331, such as, or example, a CD-ROM or other optical media. The magnetic hard disk drive 327, magnetic disk drive 328, and optical disk drive 330 are connected to the system bus 323 by hard disk drive interface 332, magnetic disk drive-interface 333, and optical drive interface 334, respectively. The drives and their associated computer-readable media provide nonvolatile storage of computer-executable instructions, data structures, program modules, and other data for the computer system 320. Although the example environment described herein employs magnetic hard disk 339, removable magnetic disk 329 and removable optical disk 331, other types of computer readable media for storing data can be used, including magnetic cassettes, flash memory cards, digital versatile disks, Bernoulli cartridges, RAMs, ROMs, and the like.

Program code means comprising one or more program modules may be stored on hard disk 339, magnetic disk 329, optical disk 331, ROM 324 or RAM 325, including an operating system 335, one or more application programs 336, other program modules 337, and program data 338. A user may enter commands and information into computer system 320 through keyboard 340, pointing device 342, or other input devices (not shown), such as, for example, a microphone, joy stick, game pad, scanner, or the like. These and other input devices can be connected to the processing unit 321 through input/output interface 346 coupled to system bus 323. Input/output interface 346 logically represents any of a wide variety of different interfaces, such as, for example, a serial port interface, a PS/2 interface, a parallel port interface, a Universal Serial Bus (“USB”) interface, or an Institute of Electrical and Electronics Engineers (“IEEE”) 1394 interface (i.e., a FireWire interface), or may even logically represent a combination of different interfaces.

A monitor 347 or other display device is also connected to system bus 323 via video interface 348. Other peripheral output devices (not shown), such as, for example, speakers and printers, can also be connected to computer system 320.

Computer system 320 is connectable to networks, such as, for example, an office-wide or enterprise-wide computer network, a home network, an intranet, and/or the Internet. Computer system 320 can exchange data with external sources, such as, for example, remote computer systems, remote applications, and/or remote databases over such networks.

Computer system 320 includes network interface 353, through which computer system 320 receives data from external sources and/or transmits data to external sources. As depicted in FIG. 3, network interface 353 facilitates the exchange of data with remote computer system 383 via link 351. Network interface 353 can logically represent one or more software and/or hardware modules, such as, for example, a network interface card and corresponding Network Driver Interface Specification (“NDIS”) stack. Link 351 represents a portion of a network (e.g., an Ethernet segment), and remote computer system 383 represents a node of the network.

Likewise, computer system 320 includes input/output interface 346, through which computer system 320 receives data from external sources and/or transmits data to external sources. Input/output interface 346 is coupled to modem 354 (e.g., a standard modem, a cable modem, or digital subscriber line (“DSL”) modem) via link 359, through which computer system 320 receives data from and/or transmits data to external sources. As depicted in FIG. 3, input/output interface 346 and modem 354 facilitate the exchange of data with remote computer system 393 via link 352. Link 352 represents a portion of a network and remote computer system 393 represents a node of the network.

While FIG. 3 represents a suitable operating environment for the present invention, the principles of the present invention may be employed in any system that is capable of, with suitable modification if necessary, implementing the principles of the present invention. The environment illustrated in FIG. 3 is illustrative only and by no means represents even a small portion of the wide variety of environments in which the principles of the present invention may be implemented.

In accordance with the present invention, modules including software components, communication managers, content managers, content management tools, and content databases as well as associated data, including, messages, message states, aggregated requests, message lists, updates, content references, and updated content can be stored and accessed from any of the computer-readable media associated with computer system 320. For example, portions of such modules and portions of associated program data may be included in operating system 335, application programs 336, program modules 337 and/or program data 338, for storage in system memory 322.

When a mass storage device, such as, for example, magnetic hard disk 339, is coupled to computer system 320, such modules and associated program data may also be stored in the mass storage device. In a networked environment, program modules depicted relative to computer system 320, or portions thereof, can be stored in remote memory storage devices, such as, system memory and/or mass storage devices associated with remote computer system 383 and/or remote computer system 393. Execution of such modules may be performed in a distributed environment as previously described.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed and desired secured by United States Letters Patent is:

1. At a computer system including a content communication manager, a method for providing software components with access to updated content, the method comprising:
an act of receiving message states from one or more software components;
an act of aggregating the received message states into a aggregated update request, the aggregated update request including name/value pairs representing the message state of each of the one or more software components;
an act of sending the aggregated update request to a content manager;
an act of receiving a message list from the content manager, the message list including one or more messages, each message in the message list corresponding to a software component and indicating if any updated content is available for the software component; and
an act of distributing the one or more messages to corresponding software components such that the software components can subsequently access any available content.

2. The method as recited in claim 1, wherein the act of receiving message states from one or more software components comprises an act of receiving message states from one or more of an application program and an operating system.

3. The method as recited in claim 1, wherein the act of aggregating the received message states into an aggregated update request comprises an act of creating a string of name/value pairs.

4. The method as recited in claim 3, further comprising include the string of name/value pairs in a URL that references the content manager.

5. The method as recited in claim 1, wherein the act of sending the aggregated update request to a content manager comprises an act of issuing an HTTP GET that includes the message states of the one or more software components.

6. The method as recited in claim 1, wherein the act of receiving a message list from the content manager comprises an act of receiving a message that contains updated content for one of the one or more software components.

7. The method as recited in claim 1, wherein the act of receiving a message list from the content manager comprises an act of receiving a message that contains a reference to updated content for one of the one or more software components.

8. The method as recited in claim 1, wherein the act of distributing the one or more messages to corresponding software components such that the software components can subsequently access any available content comprises an act delivering a message that contains updated content for a software component to the software component.

9. The method as recited in claim 1, wherein the act of distributing the one or more messages to corresponding software components such that the software components can subsequently access any available content comprises an act delivering a message that contains a reference to updated content for a software component to the software component.

10. The method as recited in claim 9, further comprising:
an act of the software component using the reference to the updated content to access the updated content.

11. At a computer system including a content manager, a method for providing software components with access to updated content, the method comprising:
an act of receiving an aggregated update request from a content communication manager, the aggregated update request including the message state of one or more software components;
an act of comparing the message state for at least one software component to a corresponding updated message state for the at least one software component;
an act of generating a message list, the message list configured to include any messages that are to be sent to the one or more software components, each message in the message list corresponding to a software component and indicating if any content is available for the software component;
an act of generating a message that indicates any updated content available to the at least one software component, the message identifying the at least one software component;
an act of including the generated message in the message list; and
an act of sending the message list to the content communication manager in response to the aggregated update request such the relevant messages can be distributed to the one or more software components.

12. The method as recited in claim 11, wherein the act of receiving an aggregated update request from a content communication manager comprises an act of receiving a string of name/value pairs, each name/value pair representing a portion of the message state of a corresponding software component.

13. The method as recited in claim 11, wherein the act of comparing the message state for at least one software component to a corresponding updated message state for the at least one software component comprises an act of comparing values in a receive string of name/value pairs to values in an update database.

14. The method as recited in claim 11, wherein the act of generating a message list comprises an act of generating a message list in accordance with a message list schema.

15. The method as recited in claim 11, wherein the act of generating a message that indicates any updated content available to the at least one software component comprises an act of generating a message that contains updated content for a software component.

16. The method as recited in claim 11, wherein the act of generating a message that indicates any updated content available to the at least one software component comprises an act of generating a message that contains a reference to updated content for a software component.

17. The method as recited in claim 11, wherein the act of generating a message that indicates any updated content available to the at least one software component comprises an act of generating a message in accordance with a message schema.

18. The method as recited in claim 11, wherein the act of including the generated message in the message list comprises an act including the generated message along with one or more other messages in the message list.

19. The method as recited in claim 11, wherein the act of sending the message list to the content communication manager in response to the aggregated update request comprises an act of sending at least one message that is responsive to the message state of each software component identified in the aggregated request.

20. A computer program product for use at a computer system including a content manager, the computer program product for implementing a method for providing software components with access to updated content, the computer program product comprising one or more computer-readable media having stored thereon computer-executable instructions that, when executed by a processor, cause the computer system to perform the following:
receive an aggregated update request from a content communication manager, the aggregated update request including the message state of one or more software components;
compare the message state for at least one software component to a corresponding updated message state for the at least one software component;
generate a message list, the message list configured to include any messages that are to be sent to the one or more software components, each message in the message list corresponding to a software component and indicating if any content is available for the software component;
generate a message that indicates any updated content available to the at least one software component, the message identifying the at least one software component;
include the generated message in the message list; and
send the message list to the content communication manager in response to the aggregated update request such the relevant messages can be distributed to the one or more software components.
